(19) United States
(12) Patent Application Publication
(10) Pub. No.: US 2017/0289167 A1
(43) Pub. Date: Oct. 5, 2017

(54) Remotely Controlling Access To A Computing Device

(71) Applicant: QUALCOMM Incorporated, San Diego, CA (US)

(72) Inventors: Vishnu Vardhan Kasilya Sudarsan, Hyderabad (IN); Phanidhar Kunala, Hyderabad (IN); Debesh Kumar Sahu, Hyderabad (IN)

(21) Appl. No.: 15/086,143

(22) Filed: Mar. 31, 2016

(51) Int. Cl. H04L 29/06

(52) U.S. Cl. CPC H04L 63/102; H04L 63/0861; H04L 63/083

(57) ABSTRACT

Embodiments include devices and methods for remotely controlling access to a first computing device. A processor of the first computing device may receive an access request input, and may capture authentication information from the user in response to the access request input. The processor of the first computing device may send an access request comprising the authentication information of the user to a second computing device. The first computing device may unlock one or more functions of the first computing device based on the received authorization message.

### BACKGROUND

For security and privacy purposes, many computing and communication devices (e.g., computers, tablets, smartphones, etc.) employ a “lock” function or similar security function that prevents access to the device until the computing device receives an input of a password, an unlocking sequence of actions, or another similar owner input to unlock the device. Providing the input to bypass the lock function typically requires physical access to the computing device.

In some cases, an owner or operator of a computing device may wish to grant access to one or more functions of the computing device, but may be physically unable to access the computing device to bypass the lock function. In some cases, another user may need urgent or emergency access to the computing device. While the owner or operator of the computing device may allow another user to access the locked device by divulging the password or unlocking sequence, this is not always desirable. Further, once unlocked, typically all of functions of the unlocked device can be used or accessed.

### SUMMARY

Various embodiments include methods that may be implemented in a variety of computing devices for remotely controlling access to a first computing device by a second computing device. Various embodiments may include receiving on the first computing device an access request input from a user, capturing authentication information from the user at the first computing device in response to the access request input, sending an access request message including the authentication information of the user from the first computing device to a second computing device based on the access request input, and unlocking one or more functions of the first computing device in response to an authorization message received from the second computing device.

In some embodiments, capturing authentication information may include one or more of capturing an image of the user, and capturing a voice recording of the user.

In some embodiments, capturing authentication information may include capturing one or more of a username and password, a fingerprint, a palm print, a voice sample, a vein pattern in a retina, a vein pattern in an extremity of the user, a venous pulse, an arterial pulse, an electrocardiogram, a blood pressure, an iris pattern, face recognition data, a handwriting sample, and a signature. Such embodiments may further include authenticating the user on the first computing device based on the captured authentication information. In such embodiments, the authentication information sent with the access request may include a message indicating that the user has been authenticated on the first computing device based on the captured authentication information.

In some embodiments, sending the access request may include sending a first message from the first computing device to the second computing device based on the access request input, receiving, at the first computing device from the second computing device, an instruction to capture the authentication information of the user based on the first message. Such embodiments may further include capturing the authentication information from the user by the first computing device in response to the instruction to capture the authentication information from the second computing device, and sending a second message including the captured authentication information of the user from the first computing device to the second computing device.

Some embodiments may further include establishing an encrypted communication link for communications between the first computing device and the second computing device in response to the received access request input, wherein the access request and the authorization message are sent over the encrypted communication link.

In some embodiments, the authorization message may include a limited authorization to use the one or more functions of the first computing device. In such embodiments, unlocking one or more functions of the first computing device based on the authorization message received from the second computing device may include unlocking the one or more functions of the first computing device based on the limited authorization.

In some embodiments, the authorization message may include an authorization condition limiting or terminating access to the one or more functions of the first computing device. Such embodiments may further include locking the one or more functions of the first computing device in response to determining that the authorization condition is met.

Some embodiments may further include sending a second access request to another second computing device in response to determining that no response is received from the second computing device.

Various embodiments may also include methods that may be implemented on a computing device for remotely enabling access to a first computing device by a second computing device. Various embodiments may include receiving on the second computing device from the first computing device an access request including authentication information of a user of the first computing device. Such embodiments may further include presenting the authentication information of the user of the first computing device by the second computing device, receiving an input from a user of the second computing device indicating approval or denial of the access request. Such embodiments may further include sending from the second computing device to the first computing device an authorization message enabling the first computing device to unlock one or more functions of the first computing device in response to receiving the input from the user of the second computing device indicating approval of the access request.

In some embodiments, receiving the access request may include receiving a first message from the first computing device by the second computing device, sending to the first computing device from the second computing device an instruction to capture the authentication information of the user in response to the first message, and receiving by the second computing device a second message from the first computing device including the authentication information of the user captured by the first computing device. In some embodiments, the authorization message may include a limited authorization to use the one or more functions of the first computing device. In some embodiments, the authorization message may include an authorization condition limiting or terminating access to one or more functions of the first computing device.

Further embodiments may include a computing device including a processor configured with processor-executable instructions to perform operations of the methods summarized above. Further embodiments may include a computing device including means for performing functions of the methods summarized above. Further embodiments may include processor-readable storage media on which are stored processor executable instructions configured to cause a processor of a mobile communication device to perform operations of the methods summarized above.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1 is a component block diagram of a communication system suitable for use with various embodiments.

FIG. 2 is a process flow diagram illustrating a method for remotely controlling access to a computing device according to various embodiments.

FIG. 3 is a process flow diagram illustrating a method for remotely controlling access to a computing device according to various embodiments.

FIG. 4 is a component block diagram of a wearable computing device suitable for implementing various embodiments.

FIG. 5 is a component block diagram of a mobile wireless communication device suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments provide methods, and computing devices configured to implement the methods, that enable the remote granting of access to one or more functions of a first computing device by a second computing device. The remote granting of access may be responsive to an access request sent from the first computing device to the second computing device. The access request may be authenticated by the second computing device based on the inclusion of one or more images of a user of the first computing device. The access granted to the first computing device may be limited to one or more functions of the first computing device, enabling a layered authorization to be granted by the second computing device to the first computing device.

The term “computing device” refers to any programmable computer or processor that can be configured with programmable instructions to perform various embodiment methods. A computing device may include one or all of wearable computing devices (including smart watches, necklaces, medallions, and any computing device configured to be worn, attached to a wearable item, or embedded in a wearable item), wireless accessory devices, wireless peripheral devices, cellular telephones, smartphones, tablet computers, Internet enabled cellular telephones, Wi-Fi enabled electronic devices, personal data assistants (PDAs), laptop computers, personal computers, and similar electronic devices equipped with a short-range radio (e.g., a Bluetooth, Peanut, ZigBee, and/or Wi-Fi radio, etc.) and/or a wide area network connection (e.g., using one or more cellular radio access technologies to communicate using a wireless wide area network transceiver, or a wired connection to a communication network). Reference to a particular type of computing device as being a mobile device or a wireless device is not intended to limit the scope of the claims unless a particular type of mobile device or wireless device is recited in the claims.

The terms “component,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device itself may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

An owner or operator of a computing device may wish to grant access to one or more functions of the computing device, but may be physically unable to access the computing device to bypass the lock function. In some cases, another user may need urgent or emergency access to the computing device. While the owner or operator of the computing device may allow another user to access the locked device by divulging the password or unlocking sequence, this is not always desirable. Further, once unlocked, typically all functions of the unlocked device can be used or accessed without further permissions from the owner.

The various embodiments may include methods, and computing devices configured to implement the methods, of remotely controlling access to a first computing device (e.g., a smart phone or a laptop) from a second computing device (e.g., a wearable computing device). In some implementations, the second computing device may be a wearable computing device, such as a smart watch, a smart pendant or medallion, smart eyewear, smart clothing, a military helmet with heads up display, or other forms of wearable computing devices.

The first communication device may receive an access request to use one or more functions of the first computing device. In some implementations, the first and second computing devices may establish a secure (e.g., encrypted) communication link. In some implementations, the first and second computing devices may establish the secure communication link in response to receiving the access request at the first computing device. The secure communication link may use one or more radio access technologies (RATs), including Wi-Fi, Bluetooth, LTE-direct, or another wireless local area network (LAN) RAT (which may include a data connection over a cellular communication network).

In some implementations, the first computing device may activate an authentication information device and may capture or obtain authentication information from the user of the first computing device. The first computing device may send to the second computing device and access request including the captured authentication information.

In some implementations, the first computing device may send a first message (e.g., a first access request message) to the second computing device. In response to the first message, the second computing device may send to the first computing device an instruction to provide authentication information from the user. In response to such an instruction, the first computing device may activate an authentication image capture device to capture or obtain authentication information from the current user of the first computing device. The first computing device may send a second message (e.g., a second access request message) including the captured authentication information of the user to the second computing device. The second computing device may receive the access request message including the authentication information from the first computing device, and may present the authentication information sent with the access request on an output device of the second computing device.

The presented authentication information may enable an authentication of the current user of the first computing device (i.e., the person requesting access to the first computing device) by the owner of that device via the second computing device. A variety of different types of authentication information may be obtained by the first computing device and provided to the second computing device to enable the user to the second computing device to decide whether to approve the requested access to the first computing device. In an embodiment, the authentication information device may be a camera and the captured authentication information may be an image or video of the user of the first computing device that may be displayed to the user of the second computing device. Such embodiments enable the user of the second computing device to recognize the person requesting access based on his or her image. In another embodiment, the authentication information device may be a microphone and the captured authentication information may be sound clip of the user of the first computing device that may be play to the user of the second computing device. Such embodiments enable the user of the second computing device to recognize the person requesting access based on his or her voice.

In further embodiments, the first computing device may authenticate the requesting user using the authentication information provided with the access request message, which may be an indication that the requesting user has been authenticated. In some embodiments, the authentication information device may be a biometric sensor and the first computing device may be configured with capabilities and data files to enable the computing device to recognize and authenticate the user of the first computing device based upon obtained biometric information. For example, the first computing device may be equipped with a finger print sensor and may compare a fingerprint of the user obtained as part of the user requesting access to the first computing device to a fingerprint data file to authenticate the user. Non-limiting of biometric sensors that may be used for this purpose include a fingerprint scanner, a retina scanner, an iris scanner, a vein pattern scanner, a blood pressure detector, a blood vessel pulse detector, an electrocardiogram sensor, a voiceprint analyzer, a touch screen input unit, a smart card scanner, a face recognition scanner, a signature pad, and/or other suitable sensors. Additionally, the first computing device may authenticate a requesting user by requiring the user to enter a user name and password pair that the first computing device may compare to a database of user names and passwords. When the first computing device authenticates the user requesting access, the authentication information transmitted by first computing device along with the access request may be a message that the requesting user has been authenticated. The second computing device may then display a message to the user of the second computing device indicating that the requesting user has been authenticated. Such a message may indicate the method used by the first computing device to authenticate the requesting user.

In response to an input from the owner, the second computing device may send an authorization message to the first computing device authorizing the use of one or more functions of the first computing device. In some implementations, the authorization message may include authorization information, such as a passcode or other information, that may unlock the one or more functions of the first computing device. In some implementations, the authorization message may include an instruction that unlocks the first computing device. Based on the authorization message, the first computing device may unlock (e.g., grant access to) the one or more functions of the first computing device.

The authorization message from the second communication device unlocking the first communication device may limit the use the one or more functions of the first computing device. For example, the authorization may limit a time, a functionality, a network access, use of one or more applications, access to certain data, a location at which the first communication device may be used, and/or another aspect of use or function of the first computing device.

In some implementations, the authorization message from the second communication device may also include a limited authorization condition. When the limited authorization condition is met, the first computing device may unlock (e.g., revoke access to) the one or more functions of the first computing device.

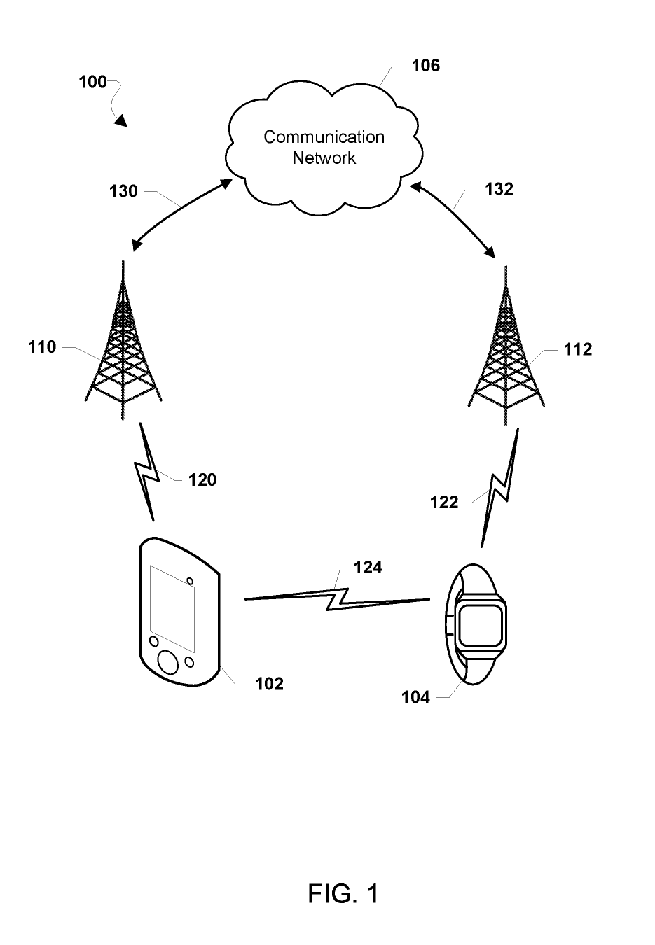

Various embodiments may be implemented within a variety of communication systems 100, an example of which is illustrated in FIG. 1. A first computing device 102 and a second computing device 104 may communicate over an inter-device wireless communication link 124. The inter-device wireless communication link 124 may be direct communication link (e.g., without an intervening device or network element), or the inter-device wireless communication link 124 may pass through one or more intervening devices such as an access point or a router. The first computing device 102 and the second computing device 104 may also communicate with each other, and with other computing devices, via a communication network 106. The communication network 106 may include a plurality of base stations (e.g., a first base station 110 and a second base station 112).

The first communication device 102 may communicate with the first base station 110 over a first wireless communication link 120. The second communication device 104 may communicate with the second base station 112 over a second wireless communication link 122. The first base station 110 may communicate with the communication network 106 over a third wired or wireless communication link 130, and the second base station 112 may communicate with the communication network 106 over a fourth wired or wireless communication link 132. The third and fourth communication links 130 and 132 may include fiber optic backhaul links, microwave backhaul links, and other suitable communication links.

The communication network 106 may support communications using one or more radio access technologies (RATs). Each of the communication links 120, 122, and 124 may be two-way wireless communication links using one or more RATs. Examples of RATs may include 3GPP Long Term Evolution (LTE), Worldwide Interoperability for Microwave Access (WiMAX), Code Division Multiple Access (CDMA), Time Division Multiple Access (TDMA), Wideband CDMA (WCDMA), Global System for Mobility (GSM), and other RATs. Examples of RATs may also include Wi-Fi, Bluetooth, Zigbee, LTE in Unlicensed spectrum (LTE-U), License Assisted Access (LAA), and MuLTEfire (a system that uses LTE on an unlicensed carrier band). While the communication links 120, 122, and 124 are illustrated as single links, each of the communication links may include a plurality of frequencies or frequency bands, each of which may include a plurality of logical channels. Additionally, each of the various communication links 120, 122, and 124 may utilize more than one RAT.

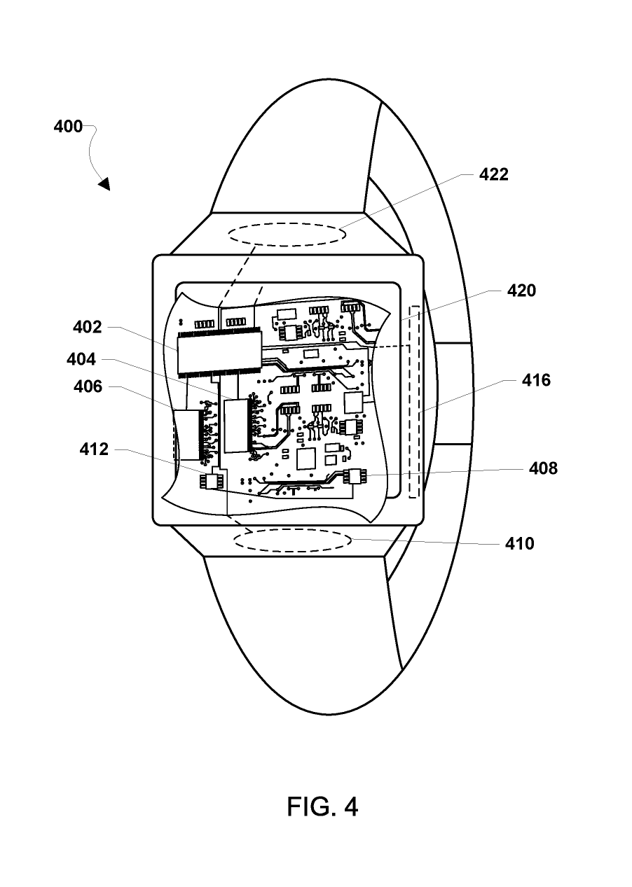

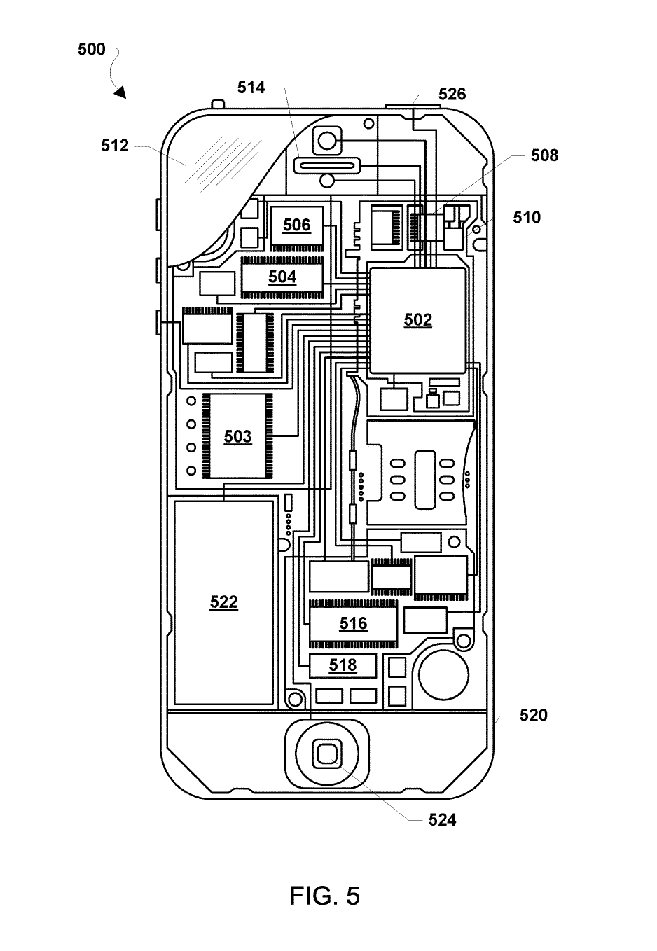

The first communication device 102 and the second communication device 104 each may include a processor that may also be coupled to a memory device. The memory device may be a non-transitory processor readable storage medium that stores processor-executable instructions. The processor executable instructions may cause a processor of the first communication device 102 and/or the second communication device 104 to perform operations that may include operations that enable remote control of access to the first computing device 102 via the second communication device 104. The memory may store an operating system, as well as user application software and application data. Further details regarding components of the first communication device 102 and the second communication device 104 are described with reference to FIGS. 4 and 5 below.

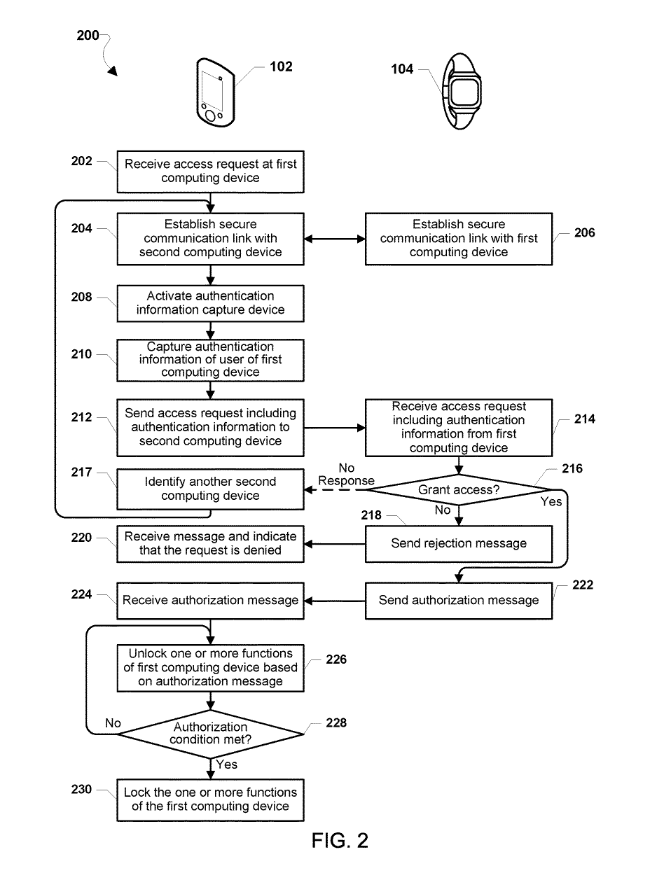

FIG. 2 illustrates a method 200 for controlling access to a first computing device remotely according to some embodiments. With reference to FIGS. 1 and 2, the method 200 may be implemented by a processor on a first computing device (e.g., the computing device 102) and a processor on the second computing device (e.g., the computing device 104).

In block 202, the processor of the first computing device may receive an access request to use one or more functions of the first computing device. In some implementations, the user interface of the first computing device may include a button, sequence of buttons, or touch screen icon(s) on a lock screen display to request access to one or more functions of the first computing device. In some implementations, the buttons or icons may enable a current user to request access to one or more functions of the first computing device. In some implementations, the buttons or icons may enable a current user to request limited access to one or more functions of the first computing device. For example, the access request may request authorization to use one or more applications of the first computing device (e.g., a phone function, a web browser, or a messaging application). A current user may request authorization to access the first computing device for a limited period of time (e.g., for a period of minutes or hours). The access request may request authorization to use the first computing device in a specified location (e.g., at home or at school). In some implementations, the access request made by a current user of the first computing device may be a request for unlimited access.

In block 204, the processor of the first computing device may initiate a secure communication link with the second communication device. The secure communication link may be made via a device-to-device (D2D) communication link, such as Bluetooth, Wi-Fi, or LTE-direct, or via an indirect communication link, such as via cellular telephone data network or encrypted communications via a public wide area network, such as the Internet. As part of initiating the secure communication link with the second communication device, the first computing device may communicate a message or information regarding the nature of the user access request received in block 202, such as an identifier of the first computing device, a type of device access requested, limitations (e.g., functions and/or time limits) on the access requested, etc. Such communicated information may inform the second computing device that the purpose for the secure communication link is to process a user access request and remote authorization of use.

In block 206, the processor of the second computing device may negotiate and complete the establishment of the secure communication link with the first computing device.

In block 208, the processor of the first computing device may activate an authentication information capture device. For example, the first computing device may activate the camera and may present an instruction to take a picture of the user of the first computing device. As another example, the first computing device may activate a front facing camera that may capture an image of a user of the first computing device. As another example, the first computing device may activate a microphone to record a voice sample of a voice of the user of the first computing device. As another example, the first computing device may activate a keyboard (physical or virtual) to capture a username and password from the user of the first computing device. As another example, the first computing device may activate one or more biometric sensors including a fingerprint scanner, a retina scanner, an iris scanner, a vein pattern scanner, a blood pressure detector, a blood vessel pulse detector, an electrocardiogram sensor, a voiceprint analyzer, a touch screen input unit, a smart card scanner, a face recognition scanner, a signature pad, and/or other suitable sensors. In some implementations, activation of the authentication information device by the first computing device processor may be in response to the user access request received in block 202 or in response to establishment of the secure communication link with the second computing device in block 204.

In block 210, the processor of the first computing device may capture authentication information of the user of the first computing device. In some implementations, the authentication information may include one or more still images of the user. In some implementations, the authentication information may include a video of the user. In some implementations, the authentication information may include a recording of the user's voice. In some implementations, the authentication information may include a username and password

In some implementations, the authentication information captured in block 210 may include a fingerprint, a palm print, a voice sample, a vein pattern in a retina, a vein pattern in an extremity of the user, a venous or arterial pulse, an electrocardiogram, a blood pressure, an iris pattern, face recognition data, a handwriting sample, a signature of the user of the first computing device and/or other suitable information. In some implementations, the authentication information may include a combination of two or more of any of the foregoing examples of authentication information.

In some implementations in which the authentication information captured on the first computing device is information that the user of the second computing device may not easily recognize, such as passwords or biometric information, the first computing device may be configured with capabilities and data files to use the captured authentication information to authenticate the user of the first computing device.

In block 212, the processor of the first computing device may send an access request including the authentication information from the first computing device to the second computing device via the secure communication link, that the processor of the second computing device receives in block 214. In some implementations, the access request sent by the processor of the first computing device may include details regarding the requested access, such as requests for use of specific functionality, specific applications, limitations on duration of use, limitations on location of use, etc. In some implementations, authentication information sent with the access request may include a message indicating that the user of the first computing device has been authenticated by the first computing device based on the captured authentication information. For example, the processor of the first computing device may authenticate the user of the first computing device based on one or more of a fingerprint, a voice sample, an image (e.g., an image of the use's iris, retina, or face), or other captured authentication information by comparing the captured data to authentication data stored the first computing device.

In block 214, the second computing device may receive the access request message along with the included authentication information, and the processor of the second computing device may present the request along with authentication information to a user. In some implementations, the second computing device may be a wearable device, such as a smart watch, that is likely to be in the possession of a user of the second computing device. As part of or in response to receiving the access request, the second computing device processor may present the authentication information sent with the access request on an output device of the second computing device. For example, the second computing device processor may display a captured image received from the first computing device on a display of the second computing device. A user of the second computing device (which may be the owner or administrator of the first computing device) may view the image to recognize or authenticate the user of the first computing device. As another example, the second computing device processor may output a voice recording of the user of the first computing device through a speaker of the second computing device, and the user of the second computing device may listen to the voice recording (e.g., the requesting user saying a code word) to recognize or authenticate the user of the first computing device.

In implementations in which the authentication information received with the access request message is an indication or message that the requesting user has been authenticated by the first computing device, the second computing device processor may output an indication (e.g., text) that the user of the first computing device has been authenticated by the first computing device. Such indication may include a visual indication (e.g., text on a display, a light emitting diode (LED) or other light, an icon, a letter, a number, or another visual indication), an audio indication (including a tone, music, a recorded word or a word generated by a speech generator or speech synthesizer, or another audio indication), a tactile or haptic indication (such as a vibration or pattern of vibrations), or another indication.

In determination block 216, the processor of the second computing device may determine whether to grant access to the one or more functions of the first computing device based on inputs received by a user of the second computing device. For example, after viewing the image of the user of the first computing device, the user of the second computing device may press a button or touch an icon on a touchscreen display to approve the requested access to the first computing device. In some implementations, the inputs by the user of the second computing device may indicate particular limitations or restrictions on the use of the first computing device approved by the user. In some implementations, the second computing device may present a user interface that enables the user to provide an input that defines one or more authorization limitations.

In response to determining that the user denied the request for access to the one or more functions of the first computing device (i.e., determination block 216=“No”), the processor of the second computing device may send a rejection message to the first computing device in block 218. In block 220, the first computing device may receive the rejection message via the secure communication link, and display or otherwise indicate to the user of the first computing device that the access request is denied.

In response to determining that the user granted the request for access to one or more functions of the first computing device (i.e., determination block 216=“Yes”), the processor of the second computing device may send an authorization message to the first computing device via the secure communication link in block 222. The authorization message may include information on limitations on use of the first computing device approved or specified by the user of the second computing device. In some implementations, the authorization may be limited to a time, a functionality, a network access, use of one or more applications, access to certain data, a location at which the first communication device may be used, and/or another aspect or function of the first computing device. For example, the limited authorization may unlock the one or more functions of the first computing device for a specified period of time (e.g., a period of minutes or hours).

In some cases, the second computing device may provide no response to the received access request (determination block 216=“No Response”). For example, the user of the second computing device may ignore the received access request or be separated from the device. As another example, the second computing device may lose or may terminate the secure communication link with the first computing device. In such cases, the processor of the first computing device may identify another second computing device in block 217, and repeat the process by establishing a secure communication link with the newly identified second computing device in block 204. In some implementations, the first computing device may be configured with data table of two or more second computing devices to which the first computing device may send an access request. In such implementations, the first computing device may send an access request to a first identified second computing device, may determine that the responses received from the first identified second computing device, and may establish a secure communication link with a second identified second computing device. Thus, in some implementations, the first computing device may be configured to send authentication request to more than one second computing device, so that in the event that a first second computing device does not respond to an access request, another access request may be sent to another second computing device.

In some implementations, after establishing a secure communication link with the second identified second computing device, the processor of the first computing device may skip the operations of block 208 and 210, and may send an access request including the previously captured authentication information to the new second computing device. In some implementations, the processor of the first computing device may capture new authentication information of the user of the first computing device in block 210.

In block 224, the first computing device may receive the authorization message from the second computing device. In some implementations, the authorization message may include a passcode or other authorization information, and/or an instruction unlocking (e.g., granting access to) one or more functions of the first computing device. Based on the authorization message the processor of the first computing device may unlock the one or more functions of the first computing device consistent with any limitations on use specified in the authorization message in block 226. In some implementations, the processor of the first communication device may not present the passcode or other authorization information to the user of the first communication device. For example, the processor of the first communication device may not display password or other authorization information on a display of the first communication device.

In some implementations, the limited authorization may direct the first computing device to unlock one or more functions of the device until a specific action has been performed on the first computing device. Examples of such a specific action include sending a message, sending a message to a particular user, making a phone call, making a phone call to a specified recipient (e.g., to a specified phone number, or to a specific contact identified on the first computing device). As another example, the limited authorization may direct the first computing device to unlock a specified range or type of messages that may be sent from the first computing device (e.g., limited to specific text, such as “I am home”). As another example, the limited authorization may direct the first computing device to unlock only an emergency phone function for an emergency messaging function (e.g., for a call or message to an emergency services provider or to a Public Safety Access Point). As another example, the limited authorization may direct the first computing device to unlock only one or more specified applications of the first computing device.

In some implementations, the limited authorization may explicitly direct the first computing device to lock (e.g., deny access to) one or more functions of the first computing device (e.g., a texting application, a video application, a gaming application, and wireless and/or cellular communication capabilities). The limited authorization may explicitly direct the first computing device to lock one or more device drivers (e.g., video drivers, audio drivers, etc.), device control functions (e.g., a Wi-Fi or cellular radio controller), or ports of the first computing device (e.g., a port used for Hypertext Transfer Markup Language (HTML) requests, or for text messaging). The limited authorization may explicitly direct the first computing device to lock access to one or more hardware devices of the first computing device.

Thus, the authorization message may include a limitation that the first computing device processor implements to place bounds on access granted to the one or more functions of the first computing device.

The authorization message may also include an authorization condition defining conditions upon which the granted access should be blocked or terminated. When the authorization condition is met, the processor of the first computing device may block or terminate access to the one or more functions of the first computing device to which access had been granted. In some implementations, the authorization condition may be based on the authorization limitation (e.g., a time limit, or the performance of a specific action). In some implementations, the authorization condition may be independent of the authorization limitation (e.g., an inactivity timer).

In block 226, the processor of the first computing device may unlock the one or more functions of the first computing device based on the authorization message and subject to any limitations or conditions identified in the authorization message.

In determination block 228, the processor of the first computing device may determine whether an authorization condition in the authorization message limiting or terminating the granted access is met.

In response to determining that the authorization condition limiting or terminating the granted access is not met (i.e., determination block 228=“No”), the processor of the first computing device may continue to permit access to the one or more unlock functions of the first computing device in block 226.

In response to determining that the authorization condition limiting or terminating access to the one or more functions of the first computing device is met (i.e., determination block 228=“Yes”), the processor of the first computing device may lock the one or more functions of the first computing device in block 230.

In some implementations, the first computing device may include a secure unit or secure module (e.g., within an operating system) or a secure kernel, that may send the access request via the secure communication link, process the received authorization message, follow instructions and limitations in the authorization message to unlock the one or more functions of the first computing device, enforce any authorization limitations imposed on the unlocking of the one or more functions, and terminate use of the allowed access when any specified authorization conditions limiting or terminating the granted access.

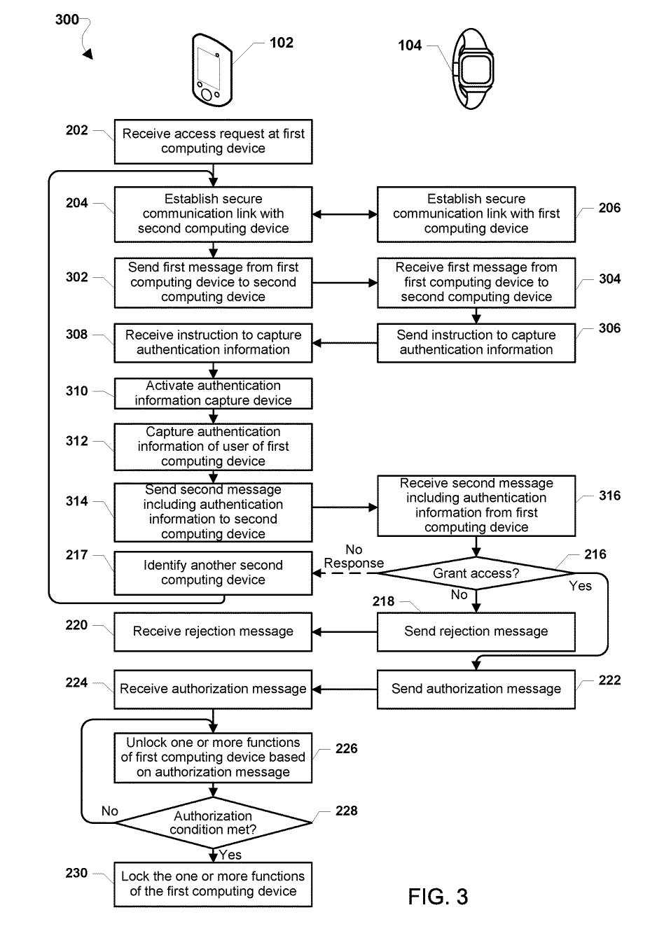

FIG. 3 illustrates a method 300 for remotely controlling access to a first computing device according to some embodiments. With reference to FIGS. 1-3, the method 300 may be implemented by a processor on a first computing device (e.g., the computing device 102) and a processor on the second computing device (e.g., the computing device 104). In blocks 202-230, the respective processors of the first and second computing devices may perform operations of like numbered blocks of the method 200 as described with reference to FIG. 2.

In block 302, the processor of the first computing device may send a first message to the second computing device. The first message may include a first access request message specified details of the requested access to one or more functions of the first computing device, such as limitations on requested use, duration or location. In block 304, the processor of the second computing device may receive the first message from the second computing device.

In block 306, the processor the second computing device may send an instruction message to the first computing device directing the device to capture authentication information of the user of the first computing device.

In block 308, the processor of the first computing device may receive the instruction to capture the authentication information from the first computing device, and activate an authentication information capture device of the first computing device in response to the instruction in block 310. For example, the first computing device may activate the camera and may present an instruction to take a picture of the user of the first computing device. As another example, the first computing device may activate a front facing camera that may capture an image of a user of the first computing device. As another example, the first computing device may activate a microphone to record a voice sample of a voice of the user of the first computing device (e.g., the user speaking a code word). As another example, the first computing device may activate a keyboard (physical or virtual) to capture a username and password from the user of the first computing device. As another example, the first computing device may activate one or more biometric sensors, such as a fingerprint scanner, a retina scanner, an iris scanner, a vein pattern scanner, a blood pressure detector, a blood vessel pulse detector, an electrocardiogram sensor, a voiceprint analyzer, a touch screen input unit, a smart card scanner, a face recognition scanner, and/or a signature pad.

In block 312, the processor of the first computing device may capture authentication information of the user of the first computing device. In some implementations, the authentication information may include one or more still images of the user. In some implementations, the authentication information may include a video of the user. In some implementations, the authentication information may include a recording of the user's voice. In some implementations, the authentication information may include a username and password. In some implementations, the authentication information may include a fingerprint, a palm print, a voice sample, a vein pattern in a retina, a vein pattern in an extremity of the user, a venous or arterial pulse, an electrocardiogram, a blood pressure, an iris pattern, face recognition data, a handwriting sample, and/or a signature of the user of the first computing device. In some implementations, the authentication information may include a combination of two or more of any of the foregoing examples of authentication information.

In some implementations, the authentication information may include a message indicating that the user of the first computing device has been authenticated on the first computing device based on the captured authentication information. For example, the processor of the first computing device may authenticate the user of the first computing device based on one or more of a fingerprint, a voice sample, an image, or other authentication information captured by the processor of the first computing device.

In block 314, the processor of the first computing device may send a second message including the authentication information from the first computing device to the second computing device.

In block 316, the processor of the second computing device may receive the second message including the authentication information from the first computing device. In some implementations, receiving the access request by the second computing device may include presenting (e.g., by the processor of the second computing device) the authentication information on an output device of the second computing device.

The processor of the second computing device may then determine whether to grant access to the one or more functions of the first computing device based on user inputs, and first and second computing devices may work together to grant or deny the requested functions of the first computing device in blocks 216-230 as described for like numbered blocks in the method 200 with reference to FIG. 2.

The various implementations may improve the function of computing devices by enabling authorization of the use of one or more functions of a first computing device remotely by a second computing device. In particular, the various implementations may improve the functioning of a computing device by remotely authorizing and enabling the use of certain limited functions of the computing device while restricting access to other functions of the computing devices. Thus, at least some functions of the computing device may be used. Further, the authorization and limitation of the accessible functions of the computing device may be controlled remotely by a second computing device.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 200 may be substituted for or combined with one or more operations of the method 300 and vice versa.

The various embodiments may be implemented within a variety of computing devices, such as a wearable computing device 400 and a mobile wireless communication device 500. FIG. 4 illustrates an example wearable computing device 400 in the form of a smart watch. With reference to FIGS. 1-4, the smart watch 400 may include a processor 402 coupled to internal memories 404 and 406. Internal memories 404 and 406 may be volatile or non-volatile memories, and may also be secure and/or encrypted memories, or unsecure and/or unencrypted memories, or any combination thereof. The processor 402 may also be coupled to a touchscreen display 420, such as a resistive-sensing touchscreen, capacitive-sensing touchscreen infrared sensing touchscreen, or the like. Additionally, the smart watch 400 may have one or more antenna 408 for sending and receiving electromagnetic radiation that may be connected to one or more wireless data links 412, such as one or more Bluetooth transceivers, Wi-Fi transceivers, LET-direct transceivers, ANT+ transceivers, Peanut transceivers, Zigbee transceivers, etc., which may be coupled to the processor 402. The smart watch 400 may also include physical virtual buttons 422 and 410 for receiving user inputs as well as a slide sensor 416 for receiving user inputs.

The processor 402 may be any programmable microprocessor, microcomputer or multiple processor chip or chips that can be configured by processor executable instructions to perform a variety of operations, including the operations of the various implementations described above. In some devices, multiple processors may be provided, such as one processor dedicated to wireless communication functions and one processor dedicated to running other applications. Software applications may be stored in an internal memory before they are accessed and loaded into the processor 402. The processor 402 may include internal memory sufficient to store the application software instructions. In many devices, the internal memory may be a volatile or nonvolatile memory, such as flash memory, or a mixture of both. For the purposes of this description, a general reference to memory refers to memory accessible by the processor 402 including internal memory or removable memory plugged into the mobile device and memory within the processor 402 itself.

FIG. 5 is a component block diagram of a mobile wireless communication device 500 suitable for implementing various embodiments. With reference to FIGS. 1-4, the mobile wireless communication device 500 may include a processor 502 coupled to a touchscreen controller 506 and an internal memory 504. The processor 502 may be one or more multi-core integrated circuits designated for general or specific processing tasks. The internal memory 504 may be volatile or non-volatile memory, and may also be secure and/or encrypted memory, or unsecure and/or unencrypted memory, or any combination thereof. The touchscreen controller 506 and the processor 502 may also be coupled to a touchscreen panel 512, such as a resistive-sensing touchscreen, capacitive-sensing touchscreen, infrared sensing touchscreen, etc. Additionally, the display of the mobile wireless communication device 500 need not have touch screen capability.

The mobile wireless communication device 500 may have two or more radio signal transceivers 508 (e.g., Peanut, Bluetooth, Zigbee, Wi-Fi, radio frequency (RF), etc.) and antennae 510, for sending and receiving communications, coupled to each other and/or to the processor 502. The transceivers 508 and antennae 510 may be used with the above-mentioned circuitry to implement the various wireless transmission protocol stacks and interfaces. The mobile wireless communication device 500 may include one or more cellular network wireless modem chip(s) 516 coupled to the processor and antennae 510 that enables communication via two or more cellular networks via two or more radio access technologies.

The mobile wireless communication device 500 may include a peripheral wireless device connection interface 518 coupled to the processor 502. The peripheral wireless device connection interface 518 may be singularly configured to accept one type of connection, or may be configured to accept various types of physical and communication connections, common or proprietary, such as USB, FireWire, Thunderbolt, or PCIe. The peripheral wireless device connection interface 518 may also be coupled to a similarly configured peripheral wireless device connection port (not shown).

The mobile wireless communication device 500 may also include speakers 514 for providing audio outputs. The mobile wireless communication device 500 may also include a housing 520, constructed of a plastic, metal, or a combination of materials, for containing all or some of the components discussed herein. The mobile wireless communication device 500 may include a power source 522 coupled to the processor 502, such as a disposable or rechargeable battery. The rechargeable battery may also be coupled to the peripheral wireless device connection port to receive a charging current from a source external to the mobile wireless communication device 500. The mobile wireless communication device 500 may also include a physical button 524 for receiving user inputs. The mobile wireless communication device 500 may also include a power button 526 for turning the mobile wireless communication device 500 on and off.

The processors 402 and 502 may be any programmable microprocessor, microcomputer or multiple processor chip or chips that can be configured by software instructions (applications) to perform a variety of functions, including the functions of various embodiments described below. In some mobile wireless devices, multiple processors 402 and 503 may be provided, such as one processor dedicated to wireless communication functions and one processor dedicated to running other applications. Typically, software applications may be stored in the internal memory 404, 406, and 504 before they are accessed and loaded into the processor 402 and 502. The processor 402 and 502 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for remotely controlling access to a first computing device by a second computing device, comprising:
receiving an access request input from a user at the first computing device;
capturing authentication information from the user at the first computing device in response to the access request input;
sending an access request message including the authentication information of the user from the first computing device to a second computing device based on the access request input; and
unlocking one or more functions of the first computing device in response to an authorization message received from the second computing device.

2. The method of claim 1, wherein capturing authentication information comprises one or more of capturing an image of the user or capturing a voice recording of the user.

3. The method of claim 1, wherein capturing authentication information comprises capturing one or more of a username and password, a fingerprint, a palm print, a voice sample, a vein pattern in a retina, a vein pattern in an extremity of the user, a venous pulse, an arterial pulse, an electrocardiogram, a blood pressure, an iris pattern, face recognition data, a handwriting sample, or a signature,
the method further comprising authenticating the user on the first computing device based on the captured authentication information,
wherein the authentication information sent with the access request message comprises a message indicating that the user has been authenticated on the first computing device based on the captured authentication information.

4. The method of claim 1, wherein sending the access request message comprises:
sending a first message from the first computing device to the second computing device based on the access request input;
receiving, at the first computing device from the second computing device, an instruction to capture the authentication information of the user based on the first message;
capturing the authentication information from the user by the first computing device in response to the instruction to capture the authentication information from the second computing device; and
sending a second message including the captured authentication information of the user from the first computing device to the second computing device.

5. The method of claim 1, further comprising:
establishing an encrypted communication link for communication between the first computing device and the second computing device in response to the received access request input,
wherein the access request message and the authorization message are sent over the encrypted communication link.

6. The method of claim 1, wherein the authorization message comprises a limited authorization to use the one or more functions of the first computing device.

7. The method of claim 6, wherein unlocking one or more functions of the first computing device based on the authorization message received from the second computing device comprises:
unlocking the one or more functions of the first computing device based on the limited authorization.

8. The method of claim 1, wherein the authorization message comprises an authorization condition limiting or terminating access to the one or more functions of the first computing device, the method further comprising:
locking the one or more functions of the first computing device in response to determining that the authorization condition is met.

9. The method of claim 1, further comprising:
sending a second access request to another second computing device in response to determining that no response is received from the second computing device.

10. A method for remotely controlling access to a first computing device by a second computing device, comprising:
receiving on the second computing device from the first computing device an access request including authentication information of a user of the first computing device;
presenting the authentication information of the user of the first computing device by the second computing device;
receiving an input from a user of the second computing device indicating approval or denial of the access request; and
sending from the second computing device to the first computing device an authorization message enabling the first computing device to unlock one or more functions of the first computing device in response to receiving the input from the user of the second computing device indicating approval of the access request.

11. The method of claim 10, wherein receiving the access request comprises:
receiving a first message from the first computing device by the second computing device;
sending to the first computing device from the second computing device an instruction to capture the authentication information of the user in response to the first message; and
receiving by the second computing device a second message from the first computing device including the authentication information of the user captured by the first computing device.

12. The method of claim 10, wherein the authorization message comprises a limited authorization to use the one or more functions of the first computing device.

13. The method of claim 10, wherein the authorization message comprises an authorization condition limiting or terminating access to one or more functions of the first computing device.

14. A computing device, comprising:
a processor configured with processor-executable instructions to perform operations comprising:
receiving an access request input from a user;
capturing authentication information from the user in response to the access request input;
sending an access request message including the authentication information of the user to a second computing device based on the access request input; and
unlocking one or more functions of the computing device in response to an authorization message received from the second computing device.

15. The computing device of claim 14, wherein the processor is configured with processor-executable instructions to perform operations such that capturing authentication information comprises one or more of capturing an image of the user or capturing a voice recording of the user.

16. The computing device of claim 14,
wherein the processor is configured with processor-executable instructions to perform operations such that capturing authentication information comprises capturing one or more of a username and password, a fingerprint, a palm print, a voice sample, a vein pattern in a retina, a vein pattern in an extremity of the user, a venous pulse, an arterial pulse, an electrocardiogram, a blood pressure, an iris pattern, face recognition data, a handwriting sample, or a signature,
wherein the processor is configured with processor-executable instructions to perform operations further comprising authenticating the user on the first computing device based on the captured authentication information, and
wherein the authentication information sent with the access request message comprises a message indicating that the user has been authenticated on the first computing device based on the captured authentication information.

17. The computing device of claim 14, wherein the processor is configured with processor-executable instructions to perform operations such that sending the access request message comprises:
sending a first message to the second computing device based on the access request input;
receiving, from the second computing device, an instruction to capture the authentication information of the user based on the first message;
capturing the authentication information from the user in response to the instruction to capture the authentication information from the second computing device; and
sending a second message including the captured authentication information of the user to the second computing device.

18. The computing device of claim 14, wherein the processor is configured with processor-executable instructions to perform operations further comprising:
establishing an encrypted communication link for communication with the second computing device in response to the received access request input,
wherein the access request message and the authorization message are sent over the encrypted communication link.

19. The computing device of claim 14, wherein the processor is configured with processor-executable instructions to perform operations such that the authorization message comprises a limited authorization to use the one or more functions of the computing device.

20. The computing device of claim 19, wherein the processor is configured with processor-executable instructions to perform operations such that unlocking one or more functions of the computing device based on the authorization message received from the second computing device comprises unlocking the one or more functions of the computing device based on the limited authorization.
